(19) United States
(12) Patent Application Publication
(10) Pub. No.: US 2022/0023924 A1
(43) Pub. Date: Jan. 27, 2022

(54) Radiator containment bag

(71) Applicant: Andrew Edward Varley, Rothley (GB)

(72) Inventor: Andrew Edward Varley, Rothley (GB)

(21) Appl. No.: 17/383,830

(22) Filed: Jul. 23, 2021

(30) Foreign Application Priority Data
Jul. 23, 2020 (GB) GB2011456.7
Mar. 8, 2021 (GB) GB2103191.9

(51) Int. Cl. B08B 17/02; B65D 33/06; B65D 33/28

(52) U.S. Cl. CPC B08B 17/025; B65D 85/68; B65D 33/28; B65D 33/06

(57) ABSTRACT

A radiator containment bag includes a bag section configured as a container and sized and shaped so that in use at least the lower end of a radiator fits within and is retained by the bag section. The bag section is formed at least partly from a waterproof material so that liquid in the bag section will be retained within the bag section. At least one containment strap is connected to the bag section and is configured to pass over and around the top of a radiator located in the bag section in use to hold the radiator in the bag section. A plurality of grab handles extends from the bag section and are configured to allow a user or users to grasp the handles to lift the

### FIELD

The present invention relates to a bag for containing and carrying a radiator or similar heat radiating (whether by convection or forced fan) device. More particularly, the present invention relates to a bag that is configured for carrying a radiator or similar, and for containing spillages and similar while the radiator or heater is removed from it's installation position for transport.

### BACKGROUND

Radiators are a common form of household heating. A typical radiator comprises a metal container having a roughly cuboid outer structure, slim or thin when viewed end-on, and formed so that it can contain a volume of water within its closed interior. The radiator can be connected via external connection fittings (usually located at the ends towards the lower edge of the radiator) to household water pipes, to allow water to flow into and out of the radiator. These water pipes form part of the hot water system of the house, and receive hot water from the hot water system. In use, the radiator is mounted to the internal wall of a room, in a convenient location. Hot water flows into the radiator from the hot water system of the house via the pipes. Radiators are formed of a conductive material (usually a metal such as iron or steel) and will heat up as the water flows through them, with this heat ‘radiated’ out from the metal structure into the room, to heat the room. The water in the heating system is usually contained within a closed system. That is, the same water is contained within the system and continuously cycled through the system as required. There is no connection for fresh water to be cycled into the system, or for older ‘used’ water to be cycled out of the system and replaced.

When radiators need replacing, it is necessary to disconnect the water pipes from the radiator's inlet and outlet. This results in water flowing out of the pipes and the radiator. As this water has been within a closed system for some time—up to several years—it can be heavily discoloured by rust and similar from inside the radiator and heating system at large. A competent engineer or plumber will take the necessary precautions to avoid spillages going on the carpet or floor of the room where the radiator is mounted by putting down containers and covers beforehand to collect water and spills as they come from the disconnected connections.

However, it is often necessary to then transport the old radiator out of the house so that it can be replaced with a new unit. As the old radiator is lifted and moved, any residual liquid contents can spill out, and this can drop onto the carpet outside of the immediate, protected area and cause staining or spill damage.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a radiator containment bag which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a radiator containment bag, comprising: a bag section configured as a container and sized and shaped so that in use at least the lower end of a radiator fits within and is retained by the bag section, the bag section formed at least partly from a waterproof material so that liquid in the bag section will be retained within the bag section; at least one containment strap connected to the bag section and configured to pass over and around the top of a radiator located in the bag section in use to hold the radiator in the bag section; a plurality of grab handles extending from the bag section and configured to allow a user or users to grasp the handles to lift the bag section and radiator in use.

In an embodiment, the bag section comprises a base and a wall, the wall formed as a unitary item extending around the perimeter of the base section.

In an embodiment, the base comprises two separate elongate parts, connected along an axis running along the length of the two elongate parts, the connection configured to allow the two halves to fold inwards and outwards.

In an embodiment, the connection comprises a flexible watertight seam.

In an embodiment, the radiator containment bag further comprises buckles connected to the outer surface of the bag section, the buckles configured to connect and retain the containment straps on the bag section.

In an embodiment, the containment strap or straps is/are configured so that a user can tighten these around a radiator in the bag section.

In an embodiment, the plurality of grab handles comprises two pairs of grab handles, each pair located towards each end of the bag section, one of each pair on each side of the bag section.

In an embodiment, the bag section further comprises a pair of magnetised flaps, one on each side of the bag section, and configured so as to be rotatable substantially about the top edge of the bag section, so as to extend upwards form the upper edge of the bag section, the magnetised flaps connecting with a large ferrous object located within the bag section.

In an embodiment, the grab handles are shaped and sized to in use extend upwards above the top edge or rim of the bag section.

In an embodiment, the radiator containment bag further comprises a draw string, the bag section configured with a draw string channel at or towards the top edge of the bag section into which the draw string locates, the channel and string configured so that a user can tighten the string to pull the top edge of the bag taught around a radiator located in the bag section.

In an embodiment, the bag section further comprises at least one strap-and-buckle located on the outer surface of the bag section, the strap-and-buckle configured so that the strap-and-buckle can be engaged to hold a portion of the bag section in place when the portion is folded to overlap itself, so that the wall of the bag section can be tightened against the sides of the when a radiator is located in the bag section.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a front view of a radiator containment bag according to a first embodiment of the invention, the radiator containment bag shown in use with a radiator, the radiator containment bag comprising an open-topped bag section configured to enclose the lower end of a radiator so as to retain fluid spillages from the radiator within the bag section, containment straps configured to extend over and around the top edge of a radiator located within the bag and to connect to themselves and/or the bag section to hold the radiator securely in the bag section, the radiator containment bag further comprising pairs of carry handles at each end of the bag, the handles configured to allow users at each end to lift and carry the radiator and bag.

FIG. 2 shows a front view of a variation or second embodiment of the radiator containment bag of FIG. 1, the radiator containment bag in this embodiment having flaps that extend upwards from substantially the centre of the top edge of the bag at each side, the flaps containing magnets, so the flap can be lifted/rotated upwards and attached to the body of a radiator within the bag to hold the bag in position on the radiator.

FIG. 3 shows a front view of a radiator containment bag according to a variation of the invention, the radiator containment bag shown in use with a radiator, the carry handles in this variation extending upwards above the top edge of the bag.

FIG. 4 shows a front view of a further variation of the bag of the present invention in use with a radiator, the top edge of the bag fitted with a drawstring to allow the top edge to be pulled in tight against the body of a radiator located within the bag.

FIG. 5 shows a front view of a further variation of the bag of the present invention in use with a radiator, the bag comprising straps that extend along the body of the bag, substantially at the centre point, the straps allowing the bag to be pulled in tight against the body of a radiator located within the bag, the straps buckling shut or closed.

FIG. 6 shows a cross-sectional end view of the embodiments of bag section of the present invention, the bag section having a base and a surrounding wall, the base formed from two rigid or semi rigid sections running lengthways along the length of the bag, the two rigid or semi rigid sections folding outwards and downwards to form a single flat base for the bag, and inwards to rest against each other, the two sections aligned against and in parallel to one another and to the surrounding wall of the bag when folded inwards, so that the bag can be stored flat, or so as the bag will return to a desired shape from being rolled or otherwise packed forstorage.

FIG. 7 shows a side perspective view of a radiator containment bag according to a an embodiment of the invention, the radiator containment bag shown in use with a radiator, the radiator containment bag comprising an open-topped bag section configured to enclose the lower end of a radiator so as to retain fluid spillages from the radiator within the bag section, containment straps configured to extend over and around the top edge of a radiator located within the bag and to connect to themselves and/or the bag section to hold the radiator securely in the bag section, the radiator containment bag further comprising pairs of carry handles at each end of the bag, the handles configured to allow users at each end to lift and carry the radiator and bag.

### DETAILED DESCRIPTION

Embodiments of the invention, and variations thereof, will now be described in detail with reference to the figures.

A first embodiment of radiator containment bag 1 is shown in FIG. 1. The radiator containment bag 1 is shown in use with a radiator 1000 which is located in the bag 1.

The radiator containment bag 1 comprises a bag section 2 that is configured as an open-topped (but otherwise closed and watertight) container, sized and shaped so that the lower end of a radiator 1000 sits reasonably snugly within and is retained by the bag section 2 (that is, the bag section 2 generally has an elongate ‘canoe’ or rectangular shape).

The bag section 2 is formed from a heavy-duty waterproof material, so that any fluid that is spilled within the bag section 2 is retained within the bag section 2.

The bag section 2 comprises a base 9 and a wall 10. The wall 10 extends as a unitary item all the way around the base 9. The wall 10 is integral with the base so that no leaks can occur between the wall 10 and base 9. As shown in FIG. 6, the base 9 is formed in two elongate parts 9a and 9b , interconnected along a central flexible watertight seam so that the two halves 9a , 9b can fold outwards to form a planar base at the bottom of the bag section 2, or fold inwards about the central seam as shown in FIG. 6. This inwards folding allows the radiator containment bag 1 to be stored flat when not in use.

Heavy duty buckles 3 are connected to the bag section 2, the buckles 3 arranged in two pairs, one of each pair located on each side of the bag section 2, each buckle 3 located substantially halfway between the mid-line or centre of the bag section, and an end of the bag section 2.

The heavy duty buckles 3 are configured to retain containment straps 4 that extend through the buckles, over the top of the radiator 1000 within the bag section 2, and under the bag section. That is, in use the straps 4 loop around and over the radiator 1000 and bag section 2. The straps 4 are configured so that they can be tightened onto the and around the radiator 1000 from this position.

Pairs of grab handles 5 are located at each end, on each side, of the bag section 2. These are sized so that users can stand at each end of the radiator containment bag 1 when it is holding radiator 1000, and lift and move the radiator containment bag 1 and radiator 1000.

In use, if an old radiator needs to be removed and replaced, the old radiator can be placed into the radiator containment bag 1 and then moved, easily and securely, with the bag acting to contain any dirty water or similar fluids that spill out of the radiator from it's connection apertures while it is being moved. This helps to prevent spills on a household's carpet or similar, that might cause issues with a customer.

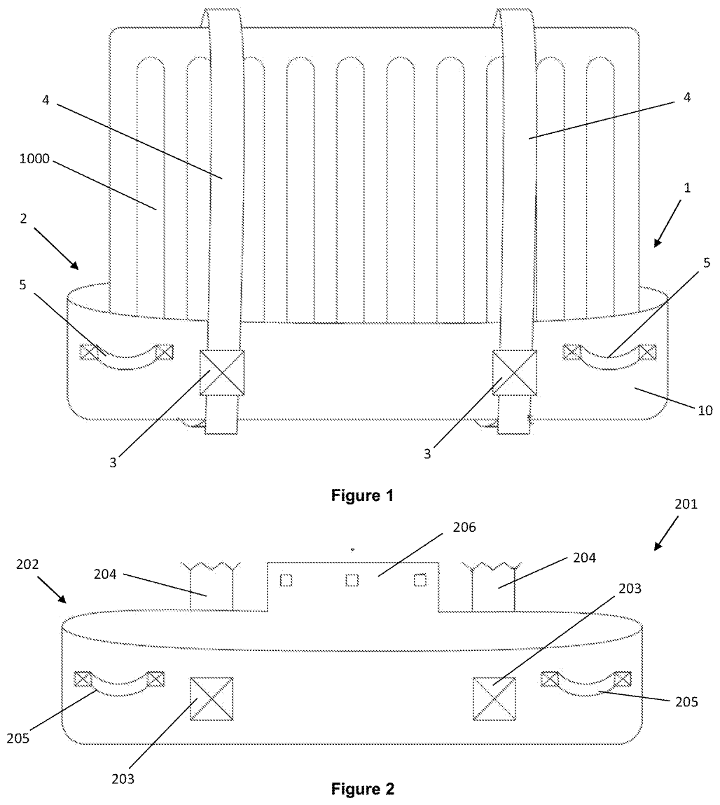

A variation of this radiator containment bag is shown in FIG. 2. The bag 201 of this variation has a bag section 202 which in this embodiment is broadly the same as for the first embodiment, but further comprises flaps 206 that extend upwards from substantially the centre of the top edge of the bag section 202 at each side, the flaps 206 containing magnets. In use, each flap 206 can be lifted or rotated upwards from outside the bag section 202 around the top edge of the bag section 202 and magnetically attached to the body of a radiator such as radiator 1000 within the bag section 202, to assist with holding the bag section 202 in position on the radiator. In variations of this embodiment, two or more magnetic flaps on each side could be used.

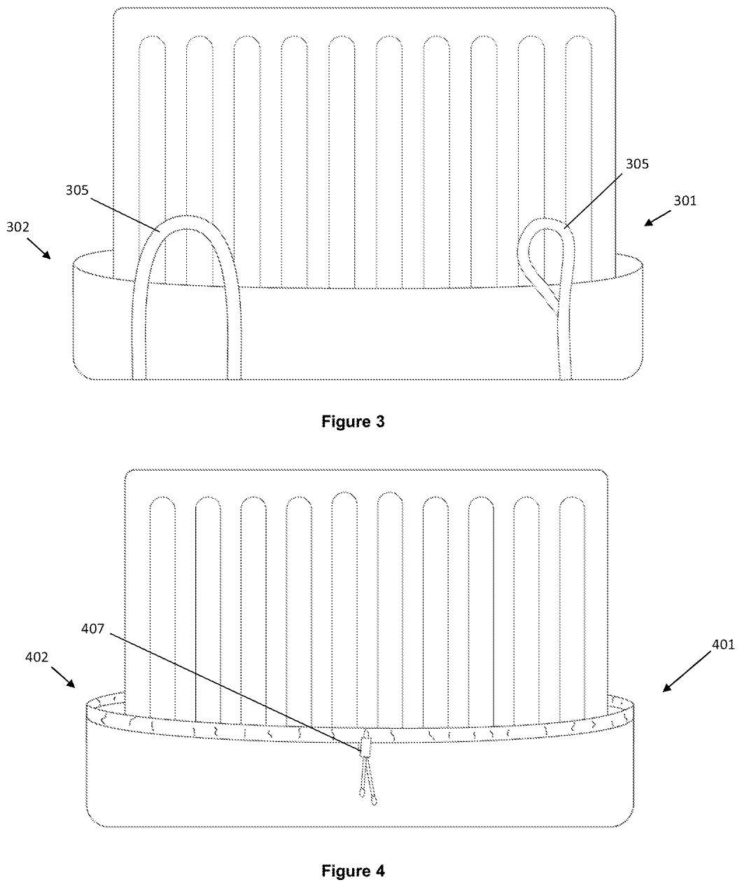

In another variation or embodiment, as shown in FIG. 3, the bag 301 has grab handles 305 that are shaped and sized so as to extend upwards from the bag section 302. This variation is potentially more useful for bags where there may be a lot of repeated lifting and then putting down, as it allows the users to lift and carry the containment bag 301 and a radiator inside the bag 301 without having to bend so far to lift and then drop the containment bag 301. This also helps to prevent the handles from being ripped off the bag, as the load is better supported mechanically with underslung straps.

In another variation or embodiment, as shown in FIG. 4, the bag 401 has bag section 402 that comprises a draw string 407 that extends around the top edge of the bag section 402. The draw string 407 is used to pull the top opening of the bag section 402 tight against the surface of a radiator located in the bag section 402. This helps to prevent liquid within the open-topped bag section 402 from spilling, and similar.

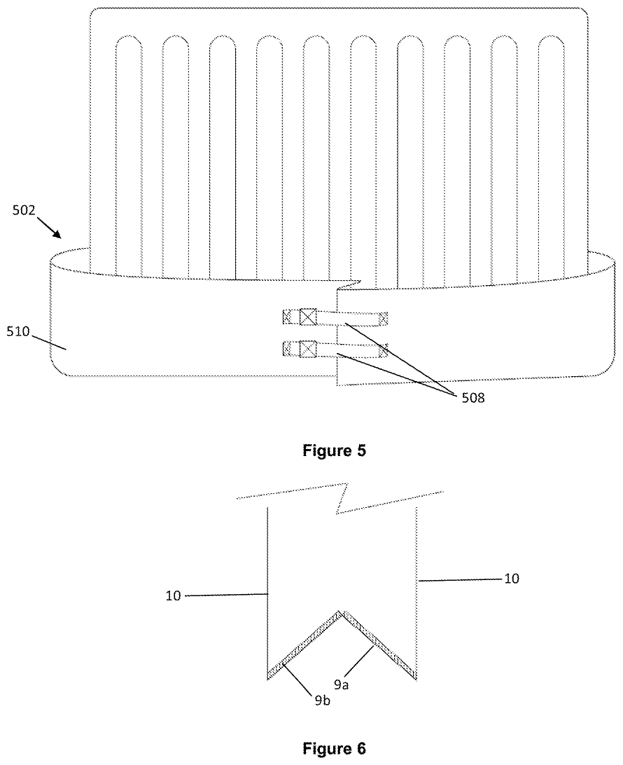

An arrangement with a similar purpose is shown in the variation in FIG. 5. The side wall 510 of the bag section 502 is configured so that it can be folded to overlap itself when ‘wrapped’ around the bottom of a radiator. This allows the bag to be used and to fit snugly against the sides of smaller radiators. A set of straps 508 is fitted to the side to allow the overlap to be pulled tight against the radiator side, so that the wall of the bag section 502 is tight against the outer surface of the radiator, to help prevent leaks.

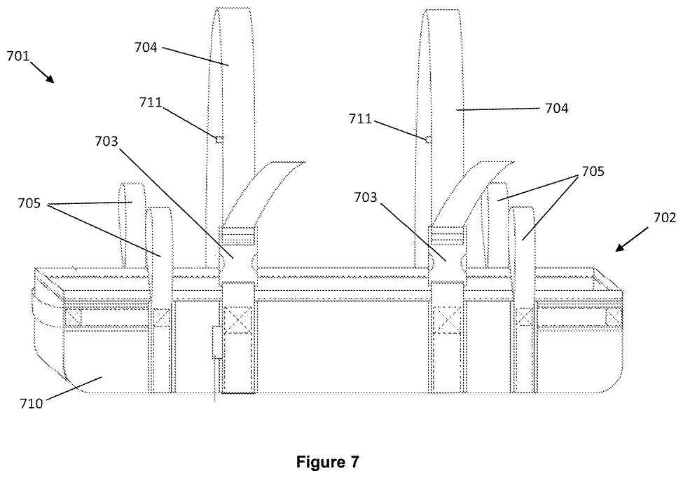

A further embodiment is shown in FIG. 7. The radiator containment bag 701 comprises a bag section 702 that is configured as an open-topped (but otherwise closed and watertight) container, sized and shaped so that the lower end of a radiator 1000 sits reasonably snugly within and is retained by the bag section 702 (that is, the bag section 702 generally has an elongate ‘canoe’ or rectangular shape).

The bag section 702 is formed from a heavy-duty waterproof material, so that any fluid that is spilled within the bag section 702 is retained within the bag section 702.

The bag section 702 comprises a base and a wall 710. The wall 710 extends as a unitary item all the way around the base. The wall 710 is integral with the base so that no leaks can occur between the wall 710 and base.

Heavy duty buckles 703 are connected to the bag section 702, the buckles 703 arranged in two pairs, one of each pair located on each side of the bag section 702, each buckle 703 located substantially halfway between the mid-line or centre of the bag section, and an end of the bag section 702.

The heavy duty buckles 703 are configured to retain containment straps 704 that extend through the buckles, over the top of the radiator 1000 within the bag section 702, and under the bag section. That is, in use the straps 704 loop around and over the radiator 1000 and bag section 702. The straps 704 are configured so that they can be tightened onto the and around the radiator 1000 from this position.

The straps 704 contain integral magnets 711, sewn into the straps 704, which magnetically attach to the body of a radiator such as radiator 1000 within the bag section to hold the straps in position against the radiator in use.

Pairs of grab handles 705 are located at each end, on each side, of the bag section 702. These are sized so that users can stand at each end of the radiator containment bag 701 when it is holding radiator 1000, and lift and move the radiator containment bag 701 and radiator 1000.

It should be noted that the variations described above can be used singly or in combination with one another. For example, the magnetic flaps 206 of the embodiment of FIG. 2 can be used in combination with the longer grab handles 305 of FIG. 3, and/or the drawstring embodiment of FIG. 4. All of the features can be used singly or in any combination as appropriate.

It should also be noted that similar numbering has been used to refer to the same or similar features on each figure. That is, for example, the bag section is numbered 2, 202, 302, etc to indicate that it is the same or similar in each embodiment. Similarly, the buckles are numbered 3, 203, 303 etc in each embodiment to indicate that they are the same or similar.

Where ‘radiator’ is referred to in this specification, this should be taken to mean radiators, and also similar devices such as hot water heaters, boilers, or similar, and should not be strictly limited or interpreted as meaning radiators only.

1. A radiator containment bag, comprising:
a bag section configured as a container and sized and shaped so that in use at least a lower end of a radiator fits within and is retained by the bag section, the bag section formed at least partly from a waterproof material so that liquid in the bag section will be retained within the bag section;
at least one containment strap connected to the bag section and configured to pass over and around a top of a radiator located in the bag section in use to hold the radiator in the bag section; and
a plurality of grab handles extending from the bag section and configured to allow a user or users to grasp the handles to lift the bag section and radiator in use.

2. The radiator containment bag as claimed in claim 1, further comprising buckles connected to an outer surface of the bag section, the buckles configured to connect and retain the at least one containment strap on the bag section.

3. The radiator containment bag as claimed in claim 1, wherein the at least one containment strap is configured so that a user can tighten the at least one containment strap around a radiator in the bag section.

4. The radiator containment bag as claimed in claim 1, wherein the plurality of grab handles comprises two pairs of grab handles, each pair located towards each end of the bag section, one of each pair on each side of the bag section.

5. The radiator containment bag as claimed in claim 1, wherein the bag section further comprises a pair of magnetized flaps, one on each side of the bag section, and configured so as to be rotatable substantially about a top edge of the bag section, so as to extend upwards form an upper edge of the bag section, the magnetized flaps connecting with a large ferrous object located within the bag section.

6. The radiator containment bag as claimed in claim 1, wherein the plurality of grab handles are shaped and sized to in use extend upwards above a top edge or rim of the bag section.

7. The radiator containment bag as claimed in claim 1, further comprising a draw string, the bag section configured with a draw string channel at or towards a top edge of the bag section into which the draw string locates, the draw string channel and string configured so that a user can tighten the string to pull the top edge of the bag section taught around a radiator located in the bag section.

8. The radiator containment bag as claimed in claim 1, wherein the bag section further comprises at least one strap-and-buckle located on an outer surface of the bag section, the at least one strap-and-buckle configured so that the at least one strap-and-buckle can be engaged to hold a portion of the bag section in place when the portion is folded to overlap itself, so that a wall of the bag section can be tightened against sides of the bag section when a radiator is located in the bag section.

9. The radiator containment bag as claimed in claim 1, wherein the bag section comprises a base and a wall, the wall formed as a unitary item extending around a perimeter of the base.

10. The radiator containment bag as claimed in claim 9, wherein the base comprises two separate elongate parts, connected along an axis running along a length of the two elongate parts and forming a connection, the connection configured to allow the two separate elongate parts to fold inwards and outwards.

11. The radiator containment bag as claimed in claim 10, wherein the connection comprises a flexible watertight seam.

12. The radiator containment bag as claimed in claim 9, further comprising buckles connected to an outer surface of the bag section, the buckles configured to connect and retain the at least one containment strap on the bag section.

13. The radiator containment bag as claimed in claim 12, wherein the bag section further comprises a pair of magnetized flaps, one on each side of the bag section, and configured so as to be rotatable substantially about a top edge of the bag section, so as to extend upwards form an upper edge of the bag section, the magnetized flaps connecting with a large ferrous object located within the bag section.

14. The radiator containment bag as claimed in claim 12, further comprising a draw string, the bag section configured with a draw string channel at or towards a top edge of the bag section into which the draw string locates, the draw string channel and string configured so that a user can tighten the string to pull the top edge of the bag section taught around a radiator located in the bag section.

15. The radiator containment bag as claimed in claim 12, wherein the at least one containment strap is configured so that a user can tighten the at least one containment strap around a radiator in the bag section.

16. The radiator containment bag as claimed in claim 15, wherein the plurality of grab handles are shaped and sized to in use extend upwards above a top edge or rim of the bag section.

17. The radiator containment bag as claimed in claim 15, wherein the plurality of grab handles comprises two pairs of grab handles, each pair located towards each end of the bag section, one of each pair on each side of the bag section.

18. The radiator containment bag as claimed in claim 15, wherein the bag section further comprises a pair of magnetized flaps, one on each side of the bag section, and configured so as to be rotatable substantially about a top edge of the bag section, so as to extend upwards form an upper edge of the bag section, the magnetized flaps connecting with a large ferrous object located within the bag section.

19. The radiator containment bag as claimed in claim 15, further comprising a draw string, the bag section configured with a draw string channel at or towards a top edge of the bag section into which the draw string locates, the draw string channel and string configured so that a user can tighten the string to pull the top edge of the bag section taught around a radiator located in the bag section.

20. The radiator containment bag as claimed in claim 19, wherein the bag section further comprises at least one strap-and-buckle located on an outer surface of the bag section, the at least one strap-and-buckle configured so that the at least one strap-and-buckle can be engaged to hold a portion of the bag section in place when the portion is folded to overlap itself, so that a wall of the bag section can be tightened against sides of the bag section when a radiator is located in the bag section.
